(19) United States
(12) Patent Application Publication
(10) Pub. No.: US 2013/0211803 A1
(43) Pub. Date: Aug. 15, 2013

(54) METHOD AND DEVICE FOR AUTOMATIC PREDICTION OF A VALUE ASSOCIATED WITH A DATA TUPLE

(71) Applicants: Feng Xu, Beijing (CN); De Bing Liu, Beijing (CN); Xiao Dong Gu, Beijing (CN); Zhi Bo Chen, Beijing (CN)

(72) Inventors: Feng Xu, Beijing (CN); De Bing Liu, Beijing (CN); Xiao Dong Gu, Beijing (CN); Zhi Bo Chen, Beijing (CN)

(73) Assignee: THOMSON LICENSING, Issy de Moulineaux (FR)

(21) Appl. No.: 13/879,407

(22) PCT Filed: Oct. 18, 2010
(86) PCT No.: PCT/CN2010/001630

§ 371 Date: Apr. 14, 2013

(51) Int. Cl. G06F 17/50

(52) U.S. Cl. CPC G06F 17/5018
USPC 703/2

(57) ABSTRACT

The invention relates to a method and a device for automatic prediction of a current value using a weighted average of a number of current reference values, wherein the current value is associated with a current pair consisting of a first and a second current data tuple. The method comprises using a set of reference pairs, each reference pair consisting of a first and a second reference data tuple and being associated with a reference value, for selecting the current reference values wherein the first reference data tuples, the first current data tuple and a first metric is used for selecting, determining, for each current reference value, an associated weight using the second reference data tuples of the pair associated with the respective selected reference value, the second current data tuple and a second metric, and using the current reference values and the determined weights for determining the weighted average.

### TECHNICAL FIELD

The invention is made in the field of automatic value prediction or estimation.

### BACKGROUND OF THE INVENTION

Automatic prediction of values, also known of automatic estimation of values, is used in a variety of fields. Most general, automatic prediction or estimation is a kind of system modelling. That is, any modelling of a system serves for predicting the systems behaviour.

Either the system is described explicitly in the model by describing physical and/or chemical interactions between the system's elements. This is commonly done for understanding the system's causal structure.

Or the system is treated as a black box and the model reproduces the causal and/or probabilistic relations between inputs and outputs of the system without reference to the system's elements. This is particularly advantageous for simulating the system's behaviour on a device having a significantly different structure than the modelled system. E.g. simulating functions of a nervous system where computations are realized in a highly distributed fashion on a computing device where computations are realized in a more centralized fashion. Black box modelling is also used advantageously in failure mode effect analysis.

Black box modelling commonly involves reference data. The reference data provides examples, e.g. inputs data tuples and associated outputs values, of the previously observed system's behaviour and allows—if the amount and variety of reference data reflects the system's complexity—for interpolating and thus predicting the system's behaviour into regions for which no reference data is available.

An example of such black box modelling is regression. For a given input data tuple, the system's output is predicted or estimated as an average of reference output values which the system produced in response to reference input data tuples. For improving prediction/estimation, averaging can be restricted to reference input data tuples located in a vicinity of the current input data tuple for which the output is predicted. For definition of the vicinity a metric for measuring distances between tuples is required.

The vicinity can be defined solely based on said metric or the density of reference data tuples around the input data tuple can be further taken into account. In order to provide predictions with sufficient support even in regions where reference data tuples are sparse, the vicinity can be defined as a neighbourhood comprising a predetermined number k of nearest neighbours of the given input data tuple among the reference data tuples. This is known as k-nearest neighbour regression or kNN regression.

Regression can be adapted through weighting, e.g. for use in estimating continuous variables. For instance, a prediction of a current value associated with a current data tuple can be determined using an inverse distance weighted average of reference values associated with the k-nearest neighbours of the data tuple.

### SUMMARY OF THE INVENTION

Although use of a distance metric in weighted regression provides for good predictions in general, there is still room for improvement.

The inventors propose such improvement in proposing a method for automatic prediction of a current value using a weighted average of a number of current reference values according to claim 1 wherein the current value is associated with a current pair consisting of a first and a second current data tuple and a corresponding device according to claim 7.

That proposed method comprises using a set of reference pairs, each reference pair consisting of a first and a second reference data tuple and being associated with a reference value, for selecting the current reference values wherein the first reference data tuples, the first current data tuple and a first metric is used for selecting. The method further comprises determining, for each current reference value, an associated weight using the second reference data tuples of the pair associated with the respective selected reference value, the second current data tuple and a second metric. Then, the weighted average is determined using the current reference values and the determined weights.

This separates the selection of reference values from determination of weights and provides parameters allowing for better adaptation of the model towards the system.

There are scenarios where such separation is beneficial. For instance, in an embodiment the first tuples represent artefact features comprised in images or videos and the second tuples represent content features comprised in the images or the videos and the reference values are mean observer quality scores.

In this scenario the inventors found that although mean observer quality scores result from artefacts present in the evaluated material, the impact of artefacts much depends on the content represented in the material. Sometimes, the detected artefact features of two different videos are on the same level; however, their perceptual quality is quite different. That means the video content influences the estimation of perceptually subjective quality.

In another embodiment, determining, for each current reference value, the corresponding weight comprises using the second metric for determining a distance between the second reference data tuples of the pair associated with the respective selected reference value and the current data tuple, comparing the distance with at least one threshold and selecting the corresponding weight dependent on a result of the comparing.

The number of current reference values can be pre-determined. Further at least one of said first metric and said second metric is determined by an input received via a user interface.

After prediction, the current pair can be added to a different set of reference pairs used for a further prediction of a further value associated with a different current pair, said further prediction further using said prediction.

The proposed device for automatic prediction of a current value using a weighted average of a number of current reference values comprises means storing a set of pairs of first and second reference data tuples and associated reference values. It further comprises retrieving means for selectively retrieving the current reference values from the storing means, said means for retrieving being adapted for using a set of reference pairs, each reference pair consisting of a first and a second reference data tuple and being associated with a reference value, wherein the first reference data tuples, the first current data tuple and a first metric is used for selecting. And it comprises means for determining, for each current reference value, an associated weight using the second reference data tuples of the pair associated with the respective selected reference value, the second current data tuple and a second metric, and means using the current reference values and the determined weights for determining the weighted average.

In an embodiment, the device further comprises a user interface for receiving an input, said input determining at least one of said first distance metric and said second distance metric.

The features of further advantageous embodiments are specified in the dependent claims.

### BRIEF DESCRIPTION OF THE DRAWINGS

Exemplary embodiments of the invention are illustrated in the drawings and are explained in more detail in the following description. The exemplary embodiments are explained only for elucidating the invention, but not limiting the invention's disclosure, scope or spirit defined in the claims.

In the figures:

FIG. 1 depicts an exemplary flowchart of content-weighted kNN regression for VQM;

FIG. 2 depicts an example where kNN search metric and the content similarity metric can both be decided by users through the feedback and

FIG. 3 depicts an exemplary flowchart of content-weighted co-training kNN regression.

### EXEMPLARY EMBODIMENTS OF THE INVENTION

The invention may be realized on any electronic device comprising a processing device correspondingly adapted. For instance, the invention may be realized in a single processing device like a personal computer, a network of processing devices or the like. Or, the invention may be realized in a television, a mobile phone, or a car media system.

The exemplary embodiment of the invention described in the following relates to k-nearest neighbour regression (kNN regression) used for video quality measurement (VQM) prediction of a distorted video without access to the original, undistorted video. This is called non reference VQM (NR VQM). Non-reference in this context relates to the fact that the original video is missing as reference. That is, there is no reference for the determination of distortion. But that does not imply that there is no reference for prediction of a mean observer quality score. Said reference for prediction is provided by artefact features and content features extracted from exemplary distorted videos, and the associated mean observer quality score assigned to the exemplary distorted videos. These reference data for prediction are also called training data while the current data for which prediction is made is also called test data.

Artefacts result from lossy compression, e.g. due to quantization, and transmission, e.g. packet loss. Though lossy compression is intentional, aretfacts still can be viewed as a kind of failure and their impact on the video quality is the effect of failure. Thus, VQM is a kind of failure mode effect analysis.

Content diversity is one of significant aspects to influence the subjective quality level. However, the prior art artefact (compression and/or transmission artefact) detection techniques do not account for content. Sometimes, the detected artefact features of two different videos are on the same level; however, their disturbing effect on perceptual quality is quite different due to the difference in content the two video comprise. That means, the video content will influence the perceptually subjective quality estimation. Rigorously, videos in different content types should be with different criteria on quality grading. It can be naturally assumed that the similar content types are with the similar quality criterion. Hence, in an embodiment of the invention weights for quality prediction are assigned according to the content similarity. The content similarity can be represented as the content feature similarity. If a training frame is similar to the test frame by content features, its weight in quality prediction for the test frame will be assigned with a large number, and vice versa.

That is, based on current artifacts detection techniques, the content features are employed to produce the weights for quality prediction, which could solve the content diversity problem (same artifact, but different perceptual quality). This can be employed advantageously to further improve the performance of the co-training methods by applying the content-based weight.

Thus, the exemplary embodiment described introduces content-based weight to facilitate the quality score prediction. Specifically, in the weighted kNN regression method, the weights are calculated according to the content similarity. A way to determine content similarity is measuring a content feature distance. If a training frame is similar to the test frame by content features, its weight in the kNN regression for the test frame will be assigned with a large number, and vice versa. Furthermore, the content-weighted kNN regression can be applied in the co-training method to improve the performance.

The k-Nearest-Neighbor (kNN) Regression is a simple, intuitive and efficient way to estimate the value of an unknown function in a given current point using its values in other (training or reference) points. In the feature space, let S be a set of training data. The kNN estimator is defined as the mean function value of the nearest neighbors:

$$\hat{f} ( x ) = \frac{1}{k} {\sum }_{k ∈ N ( x )} f ( {x}^{′} ) \qquad ( 1 )$$

where N(x)⊂S is the set of k nearest points to x in S and k is a parameter.

In the NR VQM, the kNN regression can be employed to predict quality scores, in which the training video data are represented as their artefact features \vec{x} (n-dimensional vector or n-tuple).

In the framework of the exemplary embodiment, the invention proposes to further make use of content features for videos, each of which is an m-dimensional feature vector \vec{y} (m-tuple).

That is, for the sake of mean observer quality score prediction each training or reference video is represented by a pair of data tuples, a feature reference data tuple and a content reference data tuple. The test video is represented by a pair of data tuples also, a current feature data tuple and a current content data tuple.

While the feature reference data tuple are used for determination of the k nearest neighbours of the current feature data tuple, the content reference data tuple are used for determination of the weights.

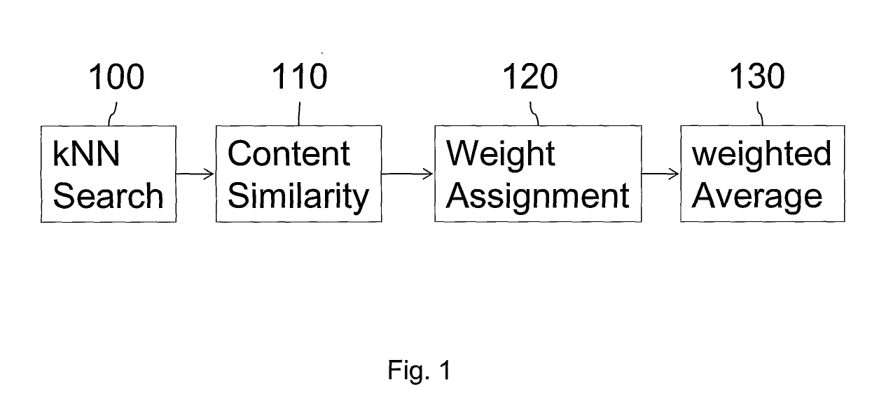

In the framework of the exemplary flowchart depicted in FIG. 1, the invention can have the following steps:

(a) For each test data, in step 100 the k nearest neighbors with artefact features are searched: To find the k nearest neighbors, any distance metric can be used, e.g. Euclidean distance, city block distance metric or any other metric can be employed. In an embodiment, the distance metric can be selected by users through feedback via a user interface. That is,

dₐᵣₜᵢ=dist(\vec{x}ᵢ,\vec{x}ⱼ) (2)

is determined in which \vec{x}ᵢ,\vec{x}ⱼ are artefact feature vectors of two frames of which one is the test frame and the other is one of the reference frames.

The artefact features can include blockiness, blur, noise, and the like. The k neighbors can be searched based on those features using Euclidean distance, city block distance, or other distances.

(b) In the k nearest neighbors, the content similarity between the test data and each training data are calculated in step 110.

The content of each frame is represented as the content features. The similarity of content features can be calculated by distance metrics, also, wherein different or same metrics can be used for features and content. Similarity of content features has a reciprocal relationship with distance in content feature space. In an embodiment, the metric can also be decided by users through feedback. That is,

d_{cont}=dist(\vec{y}ᵢ,\vec{y}ₙ), \vec{x}ᵢεN(\vec{x}ₙ) (3)

in which \vec{y}ᵢ,\vec{y}ₙ are the corresponding content feature vectors of \vec{x}ᵢ,\vec{x}ₙ.

The content features can include color and texture features, such as color correlogram, color moment, texture moment, and the like. The similarity metrics include Euclidean distance, city block distance, or other distances.

Then in step 120, each mean observer quality score assigned a training data tuple in the neighborhood is provided with a weight directly relation to the content similarity, or reciprocal relation to the distance in content feature space. The more similar the content is, the larger is the weight.

In the following to examples are given:

### Normal Reciprocal Function:

$${ω}_{i} = \frac{1}{{d}_{cont}} , {d}_{cont} > 0 \qquad ( 4 )$$

### Exponential Reciprocal Function:

wᵢ=e^{-d}^{_{cont}}, d_{cont}>0 (5)

The content-based weight is used in the regression in step 130:

$${S}_{pred} ( \overline{x} ) = \frac{1}{Z} {\sum }_{{\overline{x}}_{i} ∈ N ( \overline{x} )} {ω}_{i} ( {\overline{y}}_{i} ) {S}_{MOS} ( {\overline{x}}_{i} ) \qquad ( 6 )$$

in which \vec{x} is a test data. S_{pred} is the predicted quality score for \vec{x}, and S_{MOS} is the subjective quality scores of \vec{x}ᵢ (training data in the neighborhood of \vec{x}). wᵢ is the weight according to content similarity. And

Z=Σ_{\vec{x}}_{ᵢ}_{εN(\vec{x})}wᵢ(\vec{y}ᵢ) (7)

is the normalization factor.

Thus, the content factor is employed in the MOS prediction. If the content of a training sample is similar to the test data, it will contribute more to the MOS prediction.

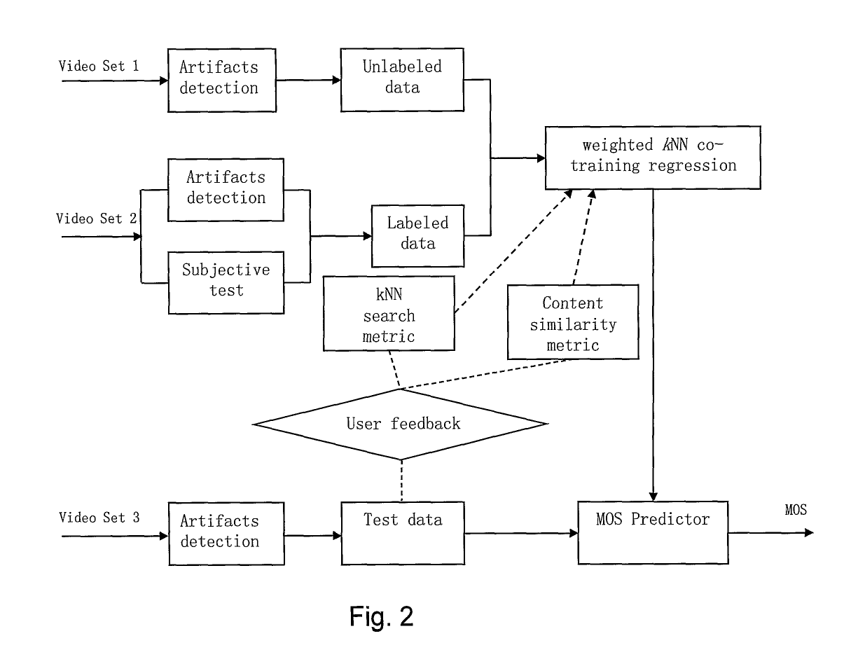

Furthermore, the content-weight can be applied to the co-training kNN regression to solve the content diversity in the VQM and facilitate the semi-supervised VQM. The kNN search metric and the content similarity metric can both be decided by users through the feedback, as exemplarily shown in FIG. 2.

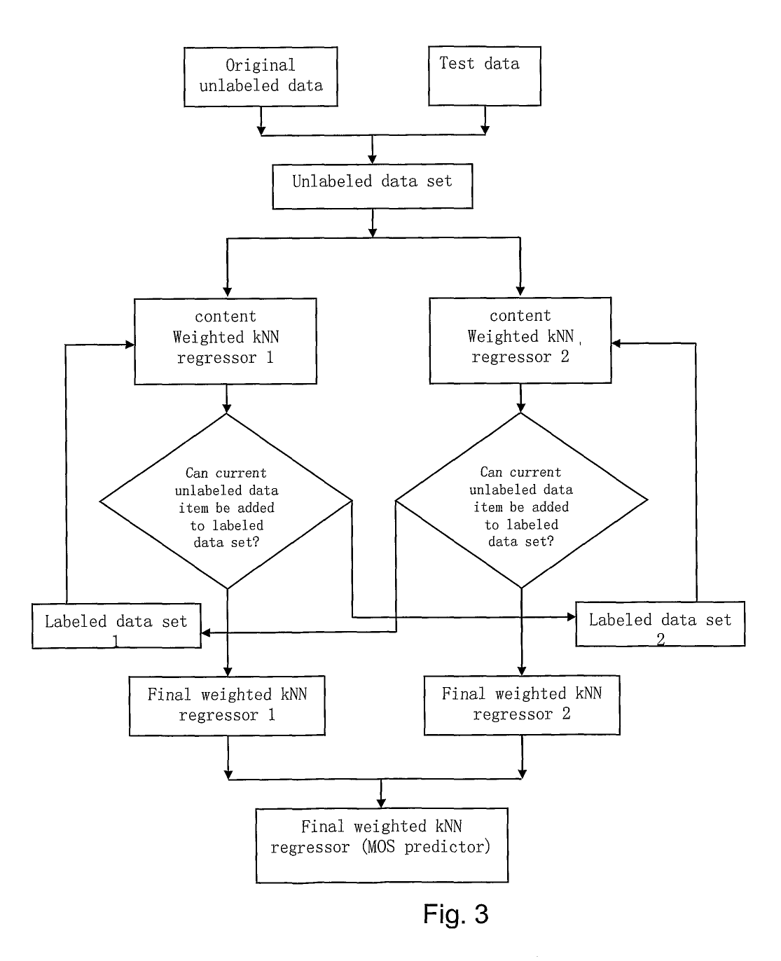

An exemplary flowchart of content-weighted co-training kNN regression is illustrated in FIG. 3.

1. Method for automatic prediction of a current value using a weighted average of a number of current reference values, the current value being associated with a current pair consisting of a first and a second current data tuple, said method comprising
using a set of reference pairs, each reference pair consisting of a first and a second reference data tuple and being associated with a reference value, for selecting the current reference values wherein the first reference data tuples, the first current data tuple and a first metric is used for selecting,
determining, for each current reference value, an associated weight using the second reference data tuples of the pair associated with the respective selected reference value, the second current data tuple and a second metric, and
using the current reference values and the determined weights for determining the weighted average.

2. Method of claim 1, wherein the first tuples represent artefact features comprised in images or videos and the second tuples represent content features comprised in the images or the videos and the reference values are mean observer quality scores.

3. Method of claim 1, wherein determining, for each current reference value, the corresponding weight comprises using the second metric for determining a distance between the second reference data tuples of the pair associated with the respective selected reference value and the current data tuple, comparing the distance with at least one threshold and selecting the corresponding weight dependent on a result of the comparing.

4. Method of claim 1, wherein the number of current reference values is pre-determined.

5. Method of claim 1, wherein at least one of said first metric and said second metric is determined by an input received via a user interface.

6. Method of claim 1, wherein, after prediction, the current pair is added to a different set of reference pairs used for a further prediction of a further value associated with a different current pair, said further prediction further using said prediction.

7. Device for automatic prediction of a current value using a weighted average of a number of current reference values, the current value being associated with a current pair consisting of a first and a second current data tuple, said device comprising
means storing a set of pairs of first and second reference data tuples and associated reference values,
retrieving means for selectively retrieving the current reference values from the storing means, said means for retrieving being adapted for using a set of reference pairs, each reference pair consisting of a first and a second reference data tuple and being associated with a reference value, wherein the first reference data tuples, the first current data tuple and a first metric is used for selecting,
means for determining, for each current reference value, an associated weight using the second reference data tuples of the pair associated with the respective selected reference value, the second current data tuple and a second metric, and
means using the current reference values and the determined weights for determining the weighted average.

8. Device of claim 7, further comprising a user interface for receiving an input, said input determining at least one of said first distance metric and said second distance metric.
